(19) United States
(12) Patent Application Publication
(10) Pub. No.: US 2021/0001421 A1
(43) Pub. Date: Jan. 7, 2021

(54) INTEGRATED POLYMER MATERIALS-SPECIAL SAW BLADE HAVING DIAMOND ABRASIVE LAYER AND PROCESSING METHOD THEREOF

(71) Applicant: KINGWAVE SAW BLADE MANUFACTURE LTD, Zhong Shan (CN)

(72) Inventors: Xu QIN, Zhong Shan (CN); Haonan HUANG, Zhong Shan (CN)

(21) Appl. No.: 16/502,716

(22) Filed: Jul. 3, 2019

(51) Int. Cl. B23D 61/02

(52) U.S. Cl. CPC B23D 61/028; C21D 9/24; B23D 61/025; B23D 61/021

(57) ABSTRACT

The present invention relates to a mechanical processing apparatus, belonging to the mechanical processing field. An integrated polymer material special saw blade with a diamond abrasive layer, including a disc-shaped blade substrate and a serration disposed on outer circumference of the disc-shaped blade substrate, the serration and the disc-shaped blade substrate are homogeneously integrated materials, and a diamond powder layer is disposed on the side of the serration and the side of a blade substrate region connected to the root of the serration. In this apparatus, the serrations are integrated with the substrate, so that the serrations are not required to be added through a complicated welding process in the later stage, effectively reducing processing difficulty and production costs, and the teeth pitch can be made smaller, which is more suitable for cutting thin-walled plastic profiles; the diamond abrasive layer on the side makes the saw blade have the dual functions of cutting and grinding, changing the single function of the traditional carbide circular saw blade only cutting and the diamond saw blade only grinding, effectively improving the abrasive resistance of the cutter teeth, and improving the service life of the cutter teeth.

### TECHNICAL FIELD

The present invention relates to the design and manufacture of a circular saw blade, and more particularly to an integrated polymer materials-special saw blade having a diamond abrasive layer and a processing method thereof.

### BACKGROUND OF THE INVENTION

With the constant development of the engineering science and materials science, in the material processing field, there are various requirements for the abrasive resistance, service life and manufacturing process difficulty of the serration, which exceed the limit physical parameters of the materials itself, and the mechanical properties of the serration produced by the prior art are at the same level as the theoretical parameter data of the materials of the serration itself. In view of the slow development of basic scientific theories, a way to greatly improve the properties of the serrations by simply innovating materials is difficult to find. Thus, how to use the existing materials, reasonably design of the serrations structure, optimize the use efficiency, service life and reduce process difficulty of the serrations, become the main direction of the development of serration research.

In consideration of the factors such as processing difficulty, material costs and service life, most of the serrations used in the field of modern material processing use serration-saw blade substrate structure, use carbon steel and other materials with low costs and easy processing as a saw blade substrate. The shape of the saw blade substrate according to the different use environment of the saw blade is machined, the serrations made of a high strength alloy such as tungsten carbide or other hard materials are weld on the formed saw blade substrate, and then grind and sharpen the serration to obtain a finished saw blade.

Such two-segmented structure of the saw blade has following disadvantages:

1. The processing technology is complicated: the substrate needs to be subject to the forming process, heat treatment and surface polishing treatment; and the serrations are required to be welded one by one on a gear welding machine, and after welding and after sandblasting, the edge of the front, side and back corners is ground on the gear grinding machine. The equipment invoiced is costly and the quality is not easy to control.

2. Since welding joint between the substrate and the serrations is a multiphase material joint, the compatibility of different phase materials is different, the mechanical strength of the joint is low and easy to be damaged;

3. The two-segmented splicing of the substrate and the serrations makes it difficult to achieve the longitudinal and lateral mechanical balance of the entire saw blade, especially in the processing of thin materials, the lateral vibration of the saw blade has badly damage to the material, the cutting grooves, the saw blade and the serration;

4. Due to the development limit of the materials science, the serration materials are still prone to wear at working temperature: a hardness of the commonly used hard alloy serrations (tungsten carbide-cobalt serrations) is HRA90.5-92.5, the wear resistance is not enough (generally can only be used for more than one month or so), blunt serrations are required to be repeatedly disassembled and ground, due to limitations of the volume and shape of the serrations, generally a saw blade can only be repaired and ground for 5-8 times, which is limited by the damage of the internal matter lattices due to the high working temperature of the sawtooth for a long time, it can only be used for about one week after each grinding, and the consumption is large and the cost is high. Since the grinding of sold serrations is a non-standard process operation, the original design parameters of the serrations cannot be guaranteed, which affects the quality of the cutting products.

5. When any saw blade works, it will produce side friction high temperature, which will seriously damage the stability of the internal metal lattices of the metal saw blade itself, and reduce the service life of the serrations; the high temperature produced by the side friction also reduce the process quality of the material being processed.

In addition to the aforementioned two-segmented saw blade, other types of saw blades are used in the prior art, but the application environment is simple and the processing precision is not high, so a simplified saw blade structures, such as an integrated type, a segment type, a wire saw and a chain saw, etc. However, such simplified and cheap sawing application environment is simple, and is mainly a choice under the compromise of price and precision, and is inconsistent with the above mentioned high-strength saw blade use requirements, and will not be discussed one by one.

Therefore, the reasonable design of saw blade can ensure the mechanical properties of various materials of the saw blade can reach their limit, and effectively extend the life of the saw blade, reduce the maintenance cost.

### BRIEF SUMMARY OF THE INVENTION

The technical problems to be solved by the present invention is to provide an integrated polymer material-special saw blade with a diamond abrasive layer and a processing method thereof, solving the problem that the service life of the polymer material processing saw blade is too short, the processing technology is complicated and the maintenance cost is high.

### Technical Solutions

An integrated polymer materials special saw blade with a diamond abrasive layer, characterized in that: comprising a disc-shaped blade substrate and a serration disposed on the outer circumference of the disc-shaped blade, the serration and the disc-shaped blade substrate are homogeneously integrated materials, and a diamond powder layer is disposed on a side of the serration and a side of a blade substrate region connected to a root of the serration;

Furthermore, a material of the serration and the disc-shaped blade substrate is a steel of the type 65Mn or SK5:

The 65Mn steel comprises following components: C: 0.62-0.70%; Si: 0.17-0.37%; Mn: 0.90-1.20%; P: ≤0.035%; S: ≤0.035%; Cu: ≤0.25%; Cr: ≤0.25%; and the remaining ingredient is Fe;

The Sk5 steel comprises following components: C: 0.80˜0.90%; Si: ≤0.35%; Mn: 0.50%; P: ≤0.03%; S: ≤0.03%; Ni: ≤0.04%; Cr: ≤0.35%; and the remaining ingredient is Fe;

Furthermore, a thickness of the diamond powder layer is 0.15-0.25 mm;

Furthermore, a particle size of the diamond powder layer is 60-80 microns, and a concentration of the diamond powder layer is 120%-150% carats/ml;

Furthermore, e angle of serration anterior angle of the saw blade uses a positive angle of 5-10 degrees;

Furthermore, the sawtooth pitch of the serration is 4.0-12.0 mm: the choice of the sawtooth pitch of the serration is determined by the thickness of the material to be cut, wherein if a material thickness is less than 1.5 mm, the tooth pitch is 4.0-7.0 mm; and if a material thickness is greater than 1.5 mm and less than 5.0 mm, the tooth pitch is 7.0-12.0 mm;

Furthermore, a sound-absorbing line is disposed on the disc-shaped blade substrate of the saw blade;

A method for processing an integrated polymer material special saw blade with a diamond abrasive layer, comprising following steps:

a. cutting a steel into a disc-shaped substrate, and performing a quenching heat treatment to the disc-shaped substrate, and the disc-shaped substrate is heat treated at a constant temperature of 780-860° C. for 5-10 mins, then the product is rapidly immersed in an oil bath of 60-90° C. for quenching, in 3 seconds the temperature is cooled to 300-350° C., then the temperature is cooled to 180-200° C. in 9 seconds, and the product is taken out through a mesh belt and shaped.

b. after quenching the workpiece, subjecting to temper heat treatment: tempering in a closed tempering furnace at a constant temperature of 380-460° C. for 4-8 h, then the temperature is cooled to 150-220° C. in the furnace without power, and the product is taken out and naturally cooled in the air to 30° C.-40° C.;

c. cutting a serration and a sound-absorbing line on the outer circular edge of the substrate; and

d. electroplating diamond powders on a side of the serration, and a side of the blade substrate connected to a root of the serration.

Furthermore, the electroplating diamond powders process comprises: degreasing, derusting and cleaning a region to be electroplated, vacuum plating a thin nickel metal layer, diamond particles are initially attached to the surface of the plating layer, then thickened coating is used to fix the diamond particles in the embedding manner, and then the process of increasing the thicknesses of the diamond and the plating layer is repeated to constantly thicken the diamond layer.

Furthermore, the most critical step of the electroplated diamond powder process is the parameters of the electroplated diamond powder: PH=5.0-5.5, temperature=42-45° C., saccharin is 0.5-2.0 g/L, 1,4-butynediol is 0.1-0.4 g/L, nickel sulfate 100-350 g/L, nickel chloride is 25-45 g/L, and phosphoric acid is 10-50 g/L.

Beneficial Effect

1. The integrated polymer material special saw blade with a diamond abrasive layer of the present invention has dual functions of cutting and grinding, and changes the single function that the traditional hard alloy circular saw blade only cutting and the diamond saw blade only grinding, effectively improves the abrasive resistance of the cutter teeth, and improves the service life of the cutter teeth;

2. The serrations are integrated with the substrate, which eliminates the need to add the serrations through later complicated welding process, effectively reduces the processing difficulty and production cost, and can make the pitch smaller, and is more suitable for cutting thin-walled plastic profiles less than 1.5 mm;

3. Since the abrasive resistance of the diamond is 8-10 times that of the hard alloy, the cutter teeth and the cutter head do not need to be ground during use, which reduces the costs of later maintenance.

### DESCRIPTION OF THE DRAWINGS

FIG. 1 is a quenching temperature curve for the workpiece;

FIG. 2 is a tempering temperature curve for the workpiece;

FIG. 3 is a top view of the saw blade;

FIG. 4 is an enlarged schematic view “a” of the serrations;

FIG. 5 is an enlarged schematic view “b” of the serrations;

FIG. 6 is a side view of a single serration; and

FIG. 7 is an actual temperature curve when the workpiece is quenched in an oil bath,

Wherein: 1—blade substrate, 2—serration, 3—sound absorbing line, 2-1—serration side diamond plating layer, 2-2—serration cutting directioned diamond plating layer.

### DETAILED DESCRIPTION OF THE PREFERRED EMBODIMENTS

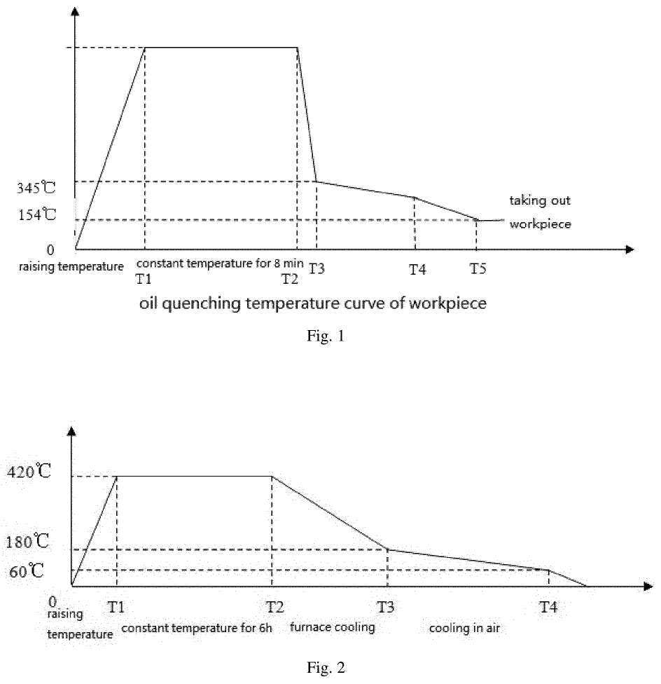

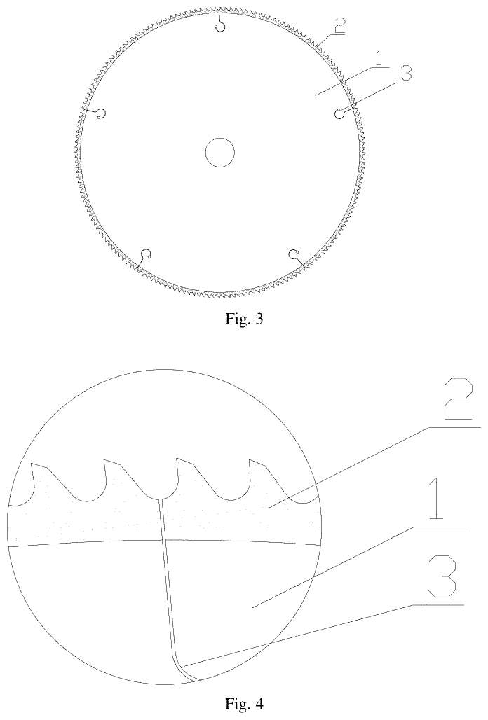

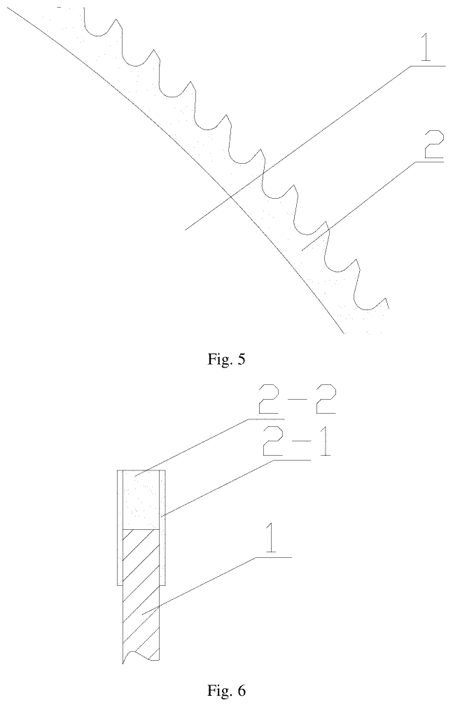

The present invention is further illustrated below with reference to specific examples and FIGS. 1-6.

In consideration of the factors such as processing difficulty, material costs and service life, most of the serrations used in modern material processing field use a serration-saw blade substrate structure, use carbon steel and other materials which are low in cost and easy to process as the saw blade substrate, the shape of the saw blade substrate is machininged according to different use environments of the saw blade, and the serrations made of a high strength alloy such as tungsten carbide or other hard materials are weld on the formed saw blade substrate, and then grind and sharpen the serrations to obtain a finished saw blade.

The present invention provides an integrated polymer material special saw blade with a diamond abrasive layer, wherein the serration and the disc-shaped blade substrate are homogeneously integrated 65Mn, SK5 type steel, diamond powder layer 2-1, 2-2 are disposed on the side of the serration, the side and the front of the serration 2 on the blade substrate 1 connected to the root of the serration, and a thickness of the diamond powder layer is 0.15-0.25 mm, making the saw blade to have double functions of cutting and grinding, which changes the single function that the traditional hard holly circular saw blade can only cut and the diamond saw blade can only grind. Due to the presence of diamond particles on the side of the serrations, the abrasive resistance of the cutter teeth is improved and the service life thereof is increased.

In the example, the tooth pitch of the serration manufactured is 4.0 and 12.0 mm: the choice of tooth pitch of the serration is determined by the thickness of the material to be cut, wherein if a material having a thickness less than 1.5 mm, the serration with the tooth pitch of 4.0 mm is selected; and if a material having a thickness greater than 1.5 mm and less than 5.0 mm, the serration with the tooth pitch of 12.0 mm is selected. Since the abrasive resistance of the diamond layer disposed on the side of the saw blade in this example is 8-10 times that of the hard alloy, there is no need to grind during use, and the cost is lower. In this example, the serrations and the blade substrate are integrated material, and the serrations is formed by grinding or wire cutting from the blade disk by a post-processing process, the sawtooth pitch can be made smaller than the hard alloy circular saw blade (embedded serration type), and it is more suitable for cutting thin-walled (1.5 mm or less) plastic profiles. The front angel e angle of the serration of the saw blade in the present example uses a positive angle of 5-10 degrees, wherein a small angle of the front angle is used for hard or brittle materials to be cut to prevent the materials from chipping during cutting; and a lager angle is used for the softer material to prevent the materials from being brushed during cutting.

In this example, the process of the heat treatment of the saw blade and electroplating the diamond are as follows:

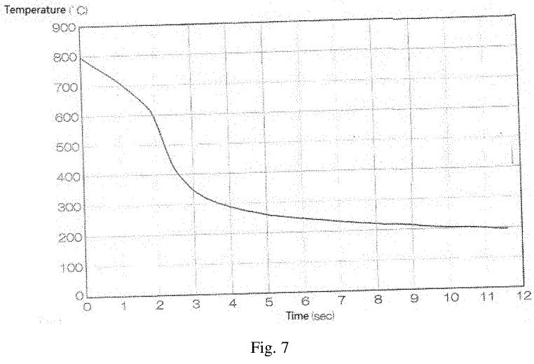

a. quenching heat treatment of the disc-shaped substrate, and the theoretical temperature change curve is shown in FIG. 1: heating to 840° C., then heat treatment at the constant temperature of 840° C. for 8 min, rapidly immersing the product in an oil bath of 60-90° C. within 3 seconds, reduce the temperature to 345° C., the temperature is lowed to 180° C. within 9 seconds, and taking out the disc-shaped substrate material. The actual changing curve of the workpiece in the oil bath is shown in FIG. 7.

b. after the quenched workpieces are packed into a string, it is pressed by a hydraulic press, and put it into a closed tempering furnace for tempering, wherein the theoretical temperature changing curve is shown in FIG. 2: raising the temperature to 420° C., then heat treating at the constant temperature of 420° C. for 6 h, cooling down to 180° C.-220° C. in the furnace, extracting and naturally cooling down in air to 30° C.-40° C., and taking out the disc-shaped substrate material.

c. cutting a serration and a sound absorbing line 3 on an outer circular edge of the substrate; and

d. electroplating diamond powder on a side of the serration, and on a side of the blade substrate connected to a root of the serration.

In the present example, the process of electroplating the diamond powder comprises: degreasing, and derusting the region to be electroplated; then washing in an acid-base pool, then performing vacuum plating to form a thin metal nickel layer of 1-3 micrometers on the surface of the substrate, to increase the bonding strength between the plating layer and the substrate; plating sand plating layer, wherein the diamond particles are initially adhered to the surface of the plating layer, then subjected to large current thick plating, thickening the plating layer to fix the diamond particles, and part of the diamond particles is embedded in the plating layer, and retaining part outside of the plating layer for grinding; finally the surface of the plating layer is plated with a layer of shiny nickel to protect the plating layer, and finally the electroplated region is cleaned and dried to obtain a molded product. In this example, the most critical step in the process of electroplating diamond powder is the parameters of the electroplated diamond powder: PH=5.2, current=2.0 A, temperature=42-45° C., the concentration of each component in the plating solution is: saccharin 1.0 g/L, 1,4-butynediol 0.2 g/L, nickel sulfate 280 g/L, nickel chloride 35 g/L, and phosphoric acid 30 g/L.

What is claimed is:

1. An integrated polymer material special saw blade with a diamond abrasive layer, characterized in that: comprises a disc-shaped blade substrate and a serration disposed on outer circumference of the disc-shaped blade substrate, the serration and the disc-shaped blade substrate are homogeneously integrated materials, and a diamond powder layer is disposed on a side of the serration and a side of a blade substrate region connected to a root of the serration.

2. The integrated polymer material special saw blade with the diamond abrasive layer according to claim 1, characterized in that: a material of the serration and the disc-shaped blade substrate is 65Mn type steel or SK5 type steel.

3. The integrated polymer material special saw blade with the diamond abrasive layer according to claim 1, characterized in that: a thickness of the diamond powder layer is 0.15-0.25 mm.

4. The integrated polymer material special saw blade with the diamond abrasive layer according to claim 1, characterized in that: a particle size of the diamond powder is 60-80 micrometers, and a concentration of the diamond powder is 120%-150% carats/ml.

5. The integrated polymer material special saw blade with the diamond abrasive layer according to claim 1, characterized in that: a front angle e angle of the serration f the saw blade has a positive angle of 5-10 degrees; and a tooth pitch of the serration is 4.0-12.0 mm.

6. The integrated polymer material special saw blade with the diamond abrasive layer according to claim 1, characterized in that: a sound absorbing line is disposed on the disc-shaped blade substrate of the saw blade.

7. A method for processing an integrated polymer material special saw blade with a diamond abrasive layer, comprising following steps:
a. quenching heat treatment and tempering heat treatment on a disc-shaped substrate;
b. cutting a serration and a sound absorbing line on an outer circular edge of the substrate; and
c. electroplating diamond powders on each side of the serration, and a side of the blade substrate connected to a root of the serration.

8. The method for processing the integrated polymer material special saw blade with the diamond abrasive layer according to claim 7, characterized in that: the quenching heat treatment step comprises: heat treating at a constant temperature of 780-860° C. for 5-10 min, a product is immersed in an oil bath for quenching, cooling the temperature to 300-350° C. within 3 seconds, then the temperature is cooled to 180-200° C. within 9 seconds; and the tempering heat treatment step comprises: tempering at a constant temperature of 380-460° C. for 4-8 h, then cooling down to 150-200° C. in a furnace, and taking the product out and in the air naturally cooling down to 30° C.-40° C.

9. The method for processing the integrated polymer material special saw blade with the diamond abrasive layer according to claim 7, characterized in that: the step of electroplating the diamond powders comprises: degreasing, derusting and cleaning a region to be electroplated, vacuum plating a thin metal nickel layer, the diamond particles are initially attached a to a surface of a plating layer, then thickened coating is used to fix the diamond particles.

10. The method for processing the integrated polymer material special saw blade with the diamond abrasive layer according to claim 9, characterized in that: PH=5.0-5.5, temperature=42-45° C., saccharin is 0.5-2.0 g/L, 1,4-butynediol is 0.1-0.4 g/L, nickel sulfate 100-350 g/L, nickel chloride is 25-45 g/L, and phosphoric acid is 10-50 g/L.
